(19) United States
(12) Patent Application Publication
(10) Pub. No.: US 2004/0170800 A1
(43) Pub. Date: Sep. 2, 2004

(54) Blackout and thermal drapery fabrics and linings using films and method therefor

(76) Inventor: Jack J. Richards, Woonsocket, RI (US)

Correspondence Address: WEISS & MOY PC, 4204 NORTH BROWN AVENUE, SCOTTSDALE, AZ, 85251, US

(21) Appl. No.: 10/761,834

(22) Filed: Jan. 20, 2004

Related U.S. Application Data
(63) Continuation-in-part of application No. 10/082,039, filed on Feb. 20, 2002.
(60) Provisional application No. 60/441,211, filed on Jan. 21, 2003.

(51) Int. Cl. B32B 5/02; B32B 27/12; B32B 31/30; B05D 1/16

(52) U.S. Cl. 428/90; 442/286; 442/394; 442/62; 442/131

(57) ABSTRACT

Blackout and thermal drapery fabrics and linings and method therefor having an impregnated blackout film capable of providing a barrier to both light and heat in an environmentally and ecologically sound way. The impregnated blackout film comprises a thermoplastic impregnated with an ingredient adapted to achieve light inhibition and thermal diminution. The impregnated blackout film may be extruded or laminated to a side of a fabric.

### RELATED APPLICATION

This application is a continuation in part of U.S. patent application, Ser. No. 10/082,039, filed Feb. 20, 2002 and also claims priority to a corresponding provisional application U.S. Serial No. 60/441,211, filed Jan. 21, 2003 in the name of the applicant of this application.

### FIELD OF THE INVENTION

This invention relates generally to draperies and drapery linings and, more specifically, to blackout and thermal drapery fabrics and linings using films and method therefor capable of providing a barrier to light and heat.

### BACKGROUND OF THE INVENTION

In previous application, U.S. patent application Ser. No. 10/082,039, incorporated as part of the current application, it was noted that it was desirable to provide drapery capable of blacking out natural light to create an atmosphere conducive to sleeping for people who need to sleep during daylight hours while providing the desirable features of conventional draperies, viz., style and appearance, and made from various types of fabrics to create a desired visual effect.

For this purpose, several blackout draperies and blackout drapery linings have been fabricated by coating a drapery fabric with an acrylic latex coat that has been mixed with a black pigment such as carbon black, which presents several serious environmental and ecological problems. Additionally, by having an outer layer of acrylic latex, rather than a fabric, many current blackout draperies and drapery linings are more likely to wear after repeated cleanings. An outer layer of acrylic latex, as opposed to a fabric also prevents the drapery from being printed on, dyed, or otherwise decorated. Furthermore, current blackout draperies and blackout drapery linings provide limited thermal barrier capabilities and are principally designed to inhibit light rather than diminishing heat. Usually specially designed fabrics are used to provide a thermal barrier effect and the resulting energy savings.

A number of applicants describe sandwich structures that provide certain light inhibiting or heat inhibiting effects. Poettgen, U.S. RE. 34,816, disclosed a reflective surgical drape for reducing the rate of heat loss in human patients during a variety of surgical procedures. Poettgen disclosed a core layer of non-conductive aluminum, at least one thermoplastic material adjacent one side of the aluminum core layer and an adsorbent non-woven material adjacent another side of the aluminum core layer. It should be noted that Poettgen is not concerned with any visual effects or with light effects of the surgical drape as required for a drapery or drapery lining of the instant disclosure.

Bergstrom, U.S. Pat. No. 3,718,528 disclosed a heat reflecting laminate which transmits light and reflects heat radiation. Bergstrom's heat reflecting laminate comprises a plastic substrate, on which is precipitated using a catalytic process, at least one coating of a metal or metals which imparts to the laminate the properties of reflecting heat radiation to a greater degree than reflecting visible light, and which is also provided with a textile reinforcing material adhered to one or both sides of the laminate. Bergstrom's heat reflecting laminate is intended as a radiation filter to replace similar glass filters, not as a drapery or drapery lining. A desired drapery material according to the current applicant's disclosure has a decorative appearance, as well as providing desired thermal and light diminishing effects. Additionally, the metals disclosed in Bergstrom, U.S. Pat. No. 3,718,528, were limited to at least one of the metals Au and Pt deposited directly on a salt-activated surface of the plastic substrate to provide a catalytic layer on the surface of the plastic substrate, with a light permeable infra-red reflecting coating superposed on the at least one of Au and Pt catalytic layer comprising at least one of the metals Ir, Co, Mn, Pt, Ta, Pd and Zn. The most suitable textile fabric disclosed in Bergstrom, U.S. Pat. No. 3,718,528 is metallized, with the same metal and method as described above and provides noticeably increased transparency. Once again, Bergstrom, U.S. Pat. No. 3,718,528 does not teach desired light diminishing effects as required for a drapery or drapery lining of the instant disclosure.

Ryan et al. WO 83/00356, disclosed a laminated insulation material comprising a substrate having at least a proportion of the area of one surface of the substrate coated with a first layer of a metallic material, and the metallic layer is at least partially overlaid by a second layer of material which masks the overlaid metallic material without substantially reducing the insulating effect of the metallic material. The laminated insulation material is suitable for use in the manufacture of roller-blinds in which case the substrate is flexible and the whole of one major surface of the substrate is wholly overlaid by the metallic material and the metallic material is wholly overlaid by the second layer. Ryan et al. disclosed the substrate as being rigid or flexible or structural or non-structural. According to Ryan et al., a flexible substrate could be a woven or non-woven fabric, felt or film made from natural or synthetic material or a mixture of natural and synthetic materials and a metallic material could itself be a laminate comprising a base layer of plastics material, e.g. a polyester film or non-plastics material, e.g. paper coated on one or both major surfaces with a layer of reflective material, with the possibility of obtaining the reflective material by aluminizing the base layer. Ryan et al. disclosed that only the substrate is treated with a fire retardant material and that the layers constituting the flexible insulation material could be affixed to adjacent layers using a thermoplastic dry film or a wet coating adhesive. Ryan et al. clearly disclosed that the purpose of the laminated insulation material is to provide for thermal losses and no mention whatsoever is made of the light blocking capabilities of the laminated insulation material as required for a drapery or drapery lining of the instant disclosure.

De Mott et al. U.S. Pat. No. 5,902,753 disclosed a barrier fabric composite comprising a textile fabric having a front surface, a back surface, interstices within the fabric, and a determinable interstitial volume; a liquid harrier enhancing thermoplastic within the interstices and on the back surface, filling at least 50% of the interstitial volume and a liquid barrier enhancing plastic coating, on the back surface of the thermoplastic, having a higher melting point or glass transition temperature (T_{g}) than the thermoplastic, and capable of withstanding temperatures of at least 350° F. The specific purpose of the De Mott et al. disclosure is to provide a fabric suitable as a barrier to spills and staining rather than as a thermal or light inhibitor. De Mott et al. disclosed that the barrier fabric composite has a barrier coating comprising liquid polyester/polyurethane rubber that is not latex applied over a thermoplastic plastic film that is pressed into a polyester textile fabric, and does not consist of any metallization component and is not fire-resistant. De Mott et al. further disclosed that in a specialized application the thermoplastic plastic film contains an opacifier such as carbon black, so that the barrier fabric composites incorporating an opacifier are suited to use as a blackout curtain for light inhibition, but does not disclose any thermal diminishing effect as required for a drapery or drapery lining of the instant disclosure. Instead De Mott et al. disclose the need for the barrier coating to have a high T_{g} for manufacturing the barrier fabric composite.

Leaderman et al., U.S. Pat. No. 5,741,582 disclosed a blackout drapery lining including a first substrate of a textile material having an inner surface and an external surface, the external surface forming a first finished surface of the drapery lining, a first adhesive layer having an opaque pigment adhered to the first substrate covering the inner surface of the first substrate to provide a substantially light impermeable barrier for the drapery lining and also including a second substrate of a textile material having an inner surface and an external surface, the inner surface of the second substrate being adhered to the first adhesive layer and the external surface of the second substrate forming a second finished surface of the drapery lining. According to Leaderman et al., more than one adhesive layer may be used, and one adhesive layer is either carbon black or a darkening pigment and remaining adhesive layers coat the darkened adhesive layer with a white or colored pigmented adhesive to hide the objectionable dark colored adhesive layer. The adhesives are preferably foamed acrylic latexes and may also contain a fire retardant. The adhesive layers form an inner portion of two outer fabric layers, which may be woven or non-woven textiles. Leaderman et al., U.S. Pat. No. 5,741,582 does not disclose a thermal diminishing effect for the blackout drapery lining as required for a drapery or drapery lining of the instant disclosure.

Miller, U.S. Pat. No. 4,790,591 disclosed a removable screen for attachment to the interior of a vehicular windshield, which inhibits the transfer of heat, solar energy, ultraviolet radiation and the like through the windshield into the interior of the vehicle. According to Miller, the removable screen includes a flexible sheet which is composed of at least a metallized plastic film. Miller, U.S. Pat. No. 4,790,591 is not a light inhibiting material as required for a drapery or drapery lining of the instant disclosure and does not include a fabric portion.

Sarver, U.S. Pat. No. 4,560,245 disclosed a special heat transfer inhibiting curtain for demountable positioning to the interior surface of a windshield of a vehicle to reduce interior heat build-up in the vehicle when it is not being operated. According to Sarver, the curtain comprises a thin flexible sheet of any suitable material, such as rubber, silicone and the like, which is light impervious, sandwiched between a highly reflective white, silver or light colored material and a non-reflective or light absorbing material. Sarver disclosed commercial sources for the curtain material comprising of suede fibers attached to silicone and the silicone further attached to polyester. Sarver, U.S. Pat. No. 4,560,245 serves a different purpose compared to the instant disclosure and is not suitable as a drapery or drapery lining of the instant disclosure.

In view of the above discussion, a need exists for a blackout drapery and blackout drapery lining capable of achieving a blackout effect in an environmentally and ecologically sound way while at the same time providing a thermal barrier effect.

### SUMMARY OF THE INVENTION

An object of the present invention is to provide a blackout drapery fabric comprising a metal containing impregnated film capable of providing a blackout effect while at the same time creating a thermal barrier effect in a way that is both environmentally as well as ecologically sound.

A further object of the present invention is to provide a blackout drapery fabric comprising an opaque impregnated film capable of providing a blackout effect while at the same time creating a thermal barrier effect in a way that is both environmentally as well as ecologically sound.

A yet further object of the present invention is to provide a blackout drapery lining fabric comprising a metal containing impregnated film capable of being coupled to a drapery fabric and providing a blackout effect while at the same time creating a thermal barrier effect in a way that is both environmentally as well as ecologically sound.

A still further object of the present invention is to provide a blackout drapery lining fabric comprising an opaque impregnated film capable of being coupled to a drapery fabric and providing a blackout effect while at the same time creating a thermal barrier effect in a way that is both environmentally as well as ecologically sound.

A further object of the present invention is to provide a method for manufacturing a blackout drapery fabric comprising a metal containing impregnated film capable of providing a blackout effect while at the same time creating a thermal barrier effect in a way that is both environmentally as well as ecologically sound.

A yet further object of the present invention is to provide a method for manufacturing a blackout drapery fabric comprising an opaque impregnated film capable of providing a blackout effect while at the same time creating a thermal barrier effect in a way that is both environmentally as well as ecologically sound.

A still further object of the present invention is to provide a method for manufacturing a blackout drapery lining fabric comprising a metal containing impregnated film capable of being coupled to a drapery fabric and providing a blackout effect while at the same time creating a thermal barrier effect in a way that is both environmentally as well as ecologically sound.

A further object of the present invention is to provide a method for manufacturing a blackout drapery lining fabric comprising an opaque impregnated film capable of being coupled to a drapery fabric and providing a blackout effect while at the same time creating a thermal barrier effect in a way that is both environmentally as well as ecologically sound.

A yet further object of the present invention is to provide a blackout and thermal barrier drapery fabric comprising an outer layer of fabric which can be decorated.

A still further object of the present invention is to provide a blackout and thermal barrier drapery lining fabric comprising an outer layer of fabric which can be decorated.

### BRIEF DESCRIPTION OF THE PREFERRED EMBODIMENTS

In accordance with one embodiment of the present invention, a blackout and thermal drapery fabric is disclosed, comprising, in combination, an impregnated blackout film having a first side and a second side, the impregnated blackout film adapted to achieve light inhibition and thermal diminution; a fabric located on one side of the impregnated blackout film and having a first side and a second side, the first side of the fabric coupled to the second side of the impregnated blackout film; and a layer of acrylic latex located on an opposite side of the impregnated blackout film and having a first side and a second side, the first side of the layer of acrylic latex coated to the first side of the impregnated blackout film to provide the blackout and thermal drapery.

In accordance with another embodiment of the present invention, a blackout and thermal drapery lining fabric is disclosed, comprising, in combination, an impregnated blackout film having a first side and a second side, the impregnated blackout film adapted to achieve light inhibition and thermal diminution; a fabric located on one side of the impregnated blackout film and having a first side and a second side, the first side of the fabric coupled to the second side of the impregnated blackout film; and a layer of acrylic latex located on an opposite side of the impregnated blackout film and having a first side and a second side, the first side of the layer of acrylic latex coated to the first side of the impregnated blackout film to provide the blackout and thermal drapery lining fabric dimensioned to be lined to a second fabric located on an opposite side of the fabric and having a first side and a second side.

In accordance with still another embodiment of the present invention, a blackout and thermal drapery fabric is disclosed comprising, in combination, an impregnated blackout film having a first side and a second side, the impregnated blackout film adapted to achieve light inhibition and thermal diminution; a first fabric located on one side of the impregnated blackout film and having a first side and a second side, the first side of the first fabric coupled to the second side of the impregnated blackout film; a second fabric located on an opposite side of the first fabric and having a first side and a second side, the second side of the first fabric coupled to the first side of the second fabric; and a layer of acrylic latex located on an opposite side of the impregnated blackout film and having a first side and a second side, the first side of the layer of acrylic latex coated to the first side of the impregnated blackout film to provide the blackout and thermal drapery fabric.

In accordance with still another embodiment of the present invention, a blackout and thermal drapery fabric is disclosed, comprising, in combination, an extruded impregnated blackout film, the extruded impregnated blackout film adapted to achieve light inhibition and thermal diminution; a fabric located on one side of the extruded impregnated blackout film and having a first side and a second side; the-extruded impregnated blackout film applied to the first side of the fabric; and a layer of acrylic latex located on an opposite side of the extruded impregnated blackout film and having a first side and a second side, the first side of the layer of acrylic latex coated to the first side of the extruded impregnated blackout film to provide the blackout and thermal drapery fabric.

In accordance with yet another embodiment of the present invention, a method for manufacturing a blackout and thermal drapery fabric is disclosed, comprising, in combination, the steps of providing an impregnated blackout film having a first side and a second side, the impregnated blackout film adapted to achieve light inhibition and thermal diminution; providing a fabric located on one side of the impregnated blackout film and having a first side and a second side; coupling the first side of the fabric to the second side of the impregnated blackout film; providing a layer of acrylic latex located on an opposite side of the impregnated blackout film and having a first side and a second side; and coating the first side of the layer of acrylic latex to the first side of the impregnated blackout film to provide the blackout and thermal drapery fabric.

In accordance with yet another embodiment of the present invention, a method for manufacturing a blackout and thermal drapery fabric is disclosed, comprising, in combination, the steps of providing at least an ingredient for an extruded impregnated blackout film, the ingredient for the extruded impregnated blackout film adapted to achieve light inhibition and thermal diminution; providing a fabric located on one side of the extruded impregnated blackout film and having a first side and a second side; extruding the ingredient to the first side of the fabric to provide the extruded impregnated blackout film; providing a layer of acrylic latex located on an opposite side of the extruded impregnated blackout film and having a first side and a second side; and coating the first side of the layer of acrylic latex to the first side of the extruded impregnated blackout film to provide the blackout and thermal drapery fabric.

In accordance with yet another embodiment of the present invention, a method for manufacturing a blackout and thermal drapery lining fabric is disclosed, comprising, in combination, the steps of providing an impregnated blackout film having a first side and a second side, the impregnated blackout film adapted to achieve light inhibition and thermal diminution; providing a fabric located on one side of the impregnated blackout film and having a first side and a second side; coupling the first side of the fabric to the second side of the impregnated blackout film; coating a layer of acrylic latex located on an opposite side of the impregnated blackout film and having a first side and a second side to the first side of the impregnated blackout film to provide the blackout and thermal drapery lining fabric dimensioned to be lined to a second fabric located on an opposite side of the fabric and having a first side and a second side.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective, partially exploded view of an example of the blackout and thermal drapery fabric of the present invention, showing a side of an impregnated blackout film coupled to a side of a fabric and an opposite side of the impregnated blackout film coupled to a side of a layer of acrylic latex.

FIG. 2 is a perspective, partially exploded view of an example of a blackout and thermal drapery lining fabric of the present invention, showing a side of the impregnated blackout film coupled to a side of a fabric, an opposite side of the impregnated blackout film coupled to a side of a layer of acrylic latex and a portion of a side of a second fabric coupled to the opposite side of the fabric.

FIG. 3 is a perspective view of a portion of a second example of the blackout and thermal drapery fabric of the present invention, showing an extruded impregnated blackout film being applied to a side of a fabric.

FIG. 4 is a perspective, partially exploded view of the portion of the second example of the blackout and thermal drapery fabric of the present invention, showing a side of the extruded impregnated blackout film coupled to the side of the fabric of FIG. 3 and an opposite side of the extruded impregnated blackout film coupled to a side of a layer of acrylic latex.

### DESCRIPTION OF THE INVENTION

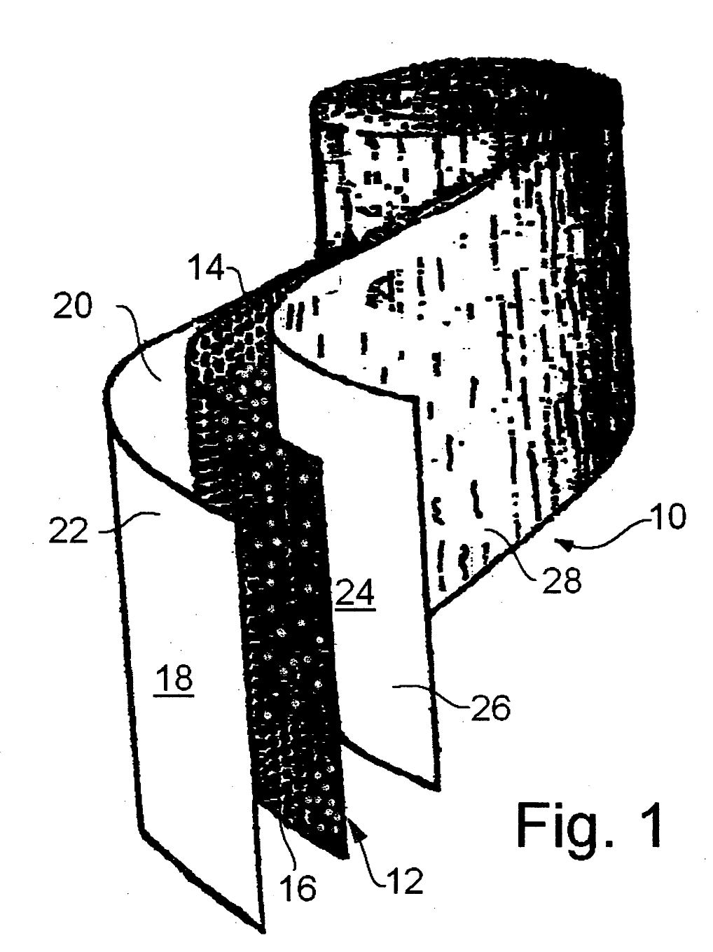

Referring to FIG. 1, an example of a blackout and thermal drapery fabric 10 is shown. The blackout and thermal drapery fabric 10 comprises an impregnated blackout film 12 having a first side 14 and a second side 16.

Preferably, the impregnated blackout film 12 comprises a thermoplastic. A preferred thermoplastic is at least polyvinyl chloride, although it should be clearly understood that substantial benefit could be derived from an alternative configuration of the blackout and thermal drapery fabric 10 in which the impregnated blackout film 12 comprises an alternative thermoplastic other than polyvinyl chloride, such as at least polyester, nylon, polypropylene, polyurethane, polyethylene, polyvinyl acetate, copolymers of each of polyvinyl chloride, polyester, nylon, polypropylene, polyurethane, polyethylene and polyvinyl acetate or the like.

In one preferred embodiment of the blackout and thermal drapery fabric 10, the impregnated blackout film 12 further comprises an ingredient of at least a metal component. The impregnated blackout film 12 is impregnated with the metal component. A preferred metal component is aluminum, although it should be clearly understood that substantial benefit could be derived from an alternative configuration of the blackout and thermal drapery fabric 10 in which the impregnated blackout film 12 comprises an aluminum alloy, titanium, tungsten, a combination thereof or blends of other metal components so long as the impregnated blackout film 12 is capable of providing light inhibition and thermal diminution.

In an alternative preferred embodiment of the blackout and thermal drapery fabric 10, the impregnated blackout film 12 further comprises an ingredient of at least a pigment, although it should be clearly understood that substantial benefit could be derived from an alternative configuration of the blackout and thermal drapery fabric 10 in which the impregnated blackout film 12 comprises an ingredient of at least a dye, a combination of ingredients of at least a pigment and at least a dye, a combination of ingredients of at least a metal component and at least a pigment, a combination of ingredients of at least a metal component and at least a dye or a combination of ingredients of at least a metal component, at least a pigment and at least a dye so long as the impregnated blackout film 12 is capable of providing light inhibition and thermal diminution. The impregnated blackout film 12 of the second preferred embodiment of the blackout and thermal drapery fabric 10 is impregnated with any combination of the ingredients as described above.

Preferably, an ingredient comprising the impregnated blackout film 12 has an optical rating of greater than about 1.5, although it should be clearly understood that substantial benefit could be derived from an alternative configuration of the blackout and thermal drapery fabric 10 in which the optical rating of the metal component, the pigment component, the dye component and combinations thereof deviate, even substantially, from the preferred optical rating in either direction.

In one preferred embodiment, the impregnated blackout film 12 comprising of an ingredient of aluminum or other metal components has a thickness of at least 2.25 mils (0.06 millimeters). In an alternative preferred embodiment, the impregnated blackout film 12 comprising of an ingredient of the pigment has a thickness of at least 2.75 mils (0.07 millimeters). It should be clearly understood that substantial benefit could be derived from an alternative configuration of the blackout and thermal drapery fabric 10 in which the thickness of the impregnated blackout film 12 comprising of an ingredient of the metal component or the pigment deviates, even substantially, from the preferred thickness in either direction.

The blackout and thermal drapery fabric 10 further comprises a layer of acrylic latex 18 having a first side 20 and a second side 22, although it should be understood that in addition to acrylic, urethanes or a blend of urethane and acrylic is also contemplated. The first side 20 of the layer of acrylic latex 18 is coated to the second side 16 of the impregnated blackout film 12.

The blackout and thermal drapery fabric 10 further comprises a fabric 24 having a first side 26 and a second side 28. The first side 26 of the fabric 24 is coated to the first side 16 of the impregnated blackout film 12.

In one embodiment, the second side 22 of the layer of acrylic latex 18 is flocked, although it should be clearly understood that substantial benefit could be derived from an alternative configuration of the blackout and thermal drapery fabric 10 in which the second side 22 of the layer of acrylic latex 18 is not flocked. The flock of the second side 22 of the layer of acrylic latex 18 comprises natural or synthetic fibers consisting of cotton, rayon, polyester, nylon and combinations thereof. The flock is applied to the second side 22 of the layer of acrylic latex 18 while the layer of acrylic latex 18 is uncured and is permanently coupled to the layer of acrylic latex 18 after heat curing.

In one embodiment, the layer of acrylic latex 18 is flame retardant, although it should be clearly understood that substantial benefit could be derived from an alternative configuration of the blackout and thermal drapery fabric 10 in which the layer of acrylic latex 18 is not flame retardant. It is to be understood that the impregnated blackout film 12 or the fabric 24, or the combination of both the impregnated blackout film 12 and the fabric 24 may also be fire-retardant, although substantial benefit could be derived from an alternative configuration of the blackout and thermal drapery fabric 10 in which neither the impregnated blackout film 12 nor the fabric 24, nor the combination of both the impregnated blackout film 12 and the fabric 24 are fire-retardant.

The fabric 24 of the blackout and thermal drapery fabric 10 comprises either woven or non-woven natural or synthetic fibers. Examples of fibers include polyester, nylon, cotton, polyethylene, polypropylene and the like, in addition to combinations of the fibers described above. The first side 26 of the fabric 24 is coupled to first side 14 of the impregnated blackout film 12 using an adhesive. A preferred adhesive is a plastisol applied between the first side 26 of the fabric 24 and the first side 14 of the impregnated blackout film 12 so that the blackout and thermal drapery fabric 10 remains substantially pliable on curing the plastisol adhesive. In use, the second side 22 of the layer of acrylic latex 18 faces a window when the blackout and thermal drapery fabric 10 is hung on a drapery rod, with the second side 28 of the fabric 24 facing into a room. The second side 28 of the fabric 24 of the blackout and thermal drapery fabric 10 can be printed or decorated to provide an aesthetic appearance.

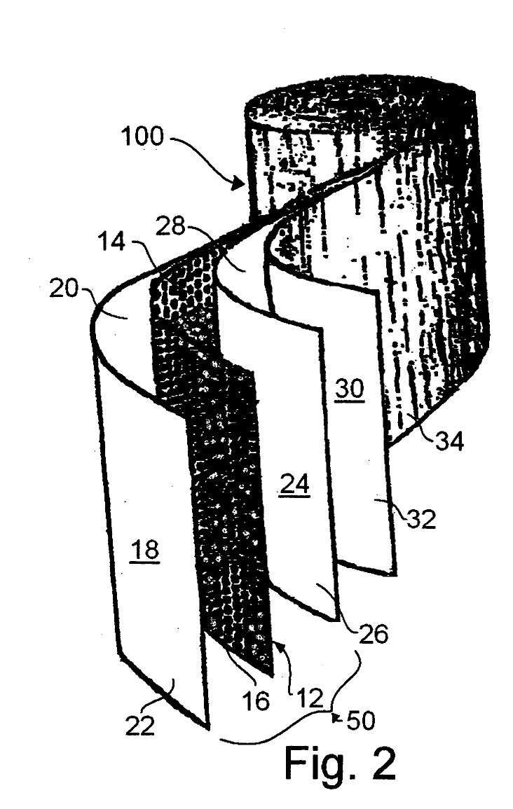

Referring now to FIG. 2, a blackout and thermal drapery lining fabric 50 is dimensioned to be lined to a second fabric 30 having a first side 32 and a second side 34 resulting in a second example of a blackout and thermal drapery fabric 100. The blackout and thermal drapery lining fabric 50 comprises a fabric 24 having a first side 26 and a second side 28. By coupling the first side 32 of the second fabric 30 to the second side 26 of the fabric 24, the second side 34 of the second fabric 30 can be printed on without any discoloration. The blackout and thermal drapery lining fabric 50 is substantially similar to the blackout and thermal drapery fabric 10 (see FIG. 1 and the description above). For this reason, the same reference numbers used in describing the features of the blackout and thermal drapery fabric 10 will be used when describing the identical features of the blackout and thermal drapery fabric 100. The first side 32 of the second fabric 30 is preferably coupled to the second side 28 of the fabric 24 by sewing, although it should be clearly understood that substantial benefit could be derived from an alternative configuration of the blackout and thermal drapery fabric 100 in which the first side 32 of the second fabric 30 is coupled to the second side 28 of the fabric 24 by means of a suitable adhesive applied between the first side 32 of the second fabric 30 and the second side 28 of the fabric 24 so that the blackout and thermal drapery fabric 100 remains substantially pliable on curing the adhesive.

The blackout and thermal drapery lining fabric 50 comprises an impregnated blackout film 12 having a first side 14 and a second side 16. The impregnated blackout film 12 comprises a thermoplastic impregnated with an ingredient of at least a metal component, at least a pigment, at least a dye or any combination of at least a metal component, at least a pigment and at least a dye, as described above for the impregnated blackout film 12 of the blackout and thermal drapery fabric 10. The. impregnated blackout film 12 of the blackout and thermal drapery lining fabric 50 has a thickness similar to the impregnated blackout film 12 of the blackout and thermal drapery-fabric 10 (see description above). The first side 26 of the fabric 24 is coupled to the first side 14 of the impregnated blackout film 12. The blackout and thermal drapery lining fabric 50 further comprises a layer of acrylic latex 18 having a first side 20 and a second side 22. It should be understood that in addition to acrylic, urethanes or a blend of urethane and acrylic is also contemplated as earlier described for the blackout and thermal drapery fabric 10. The first side 20 of the layer of acrylic latex 18 is coated to the second side 16 of the impregnated blackout film 12. The second side 22 of the layer of acrylic latex 18 may be flocked or non-flocked (see the description of the blackout and thermal drapery fabric 10, above). Each of the fabric 24 and the second fabric 30 may be woven or non-woven (see the description of the blackout and thermal drapery fabric 10, above). The impregnated blackout film 12, the fabric 24 and the layer of acrylic latex 18 of the blackout and thermal drapery lining fabric 50 may be fire retardant as described for the blackout and thermal drapery fabric 10 (see description above).

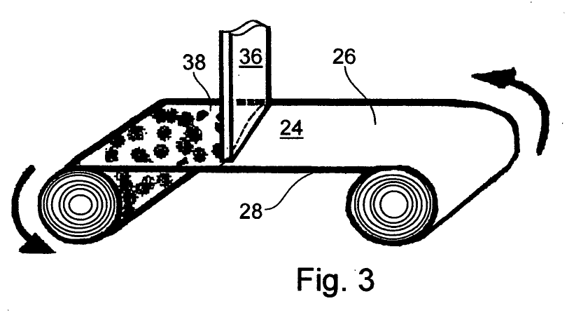

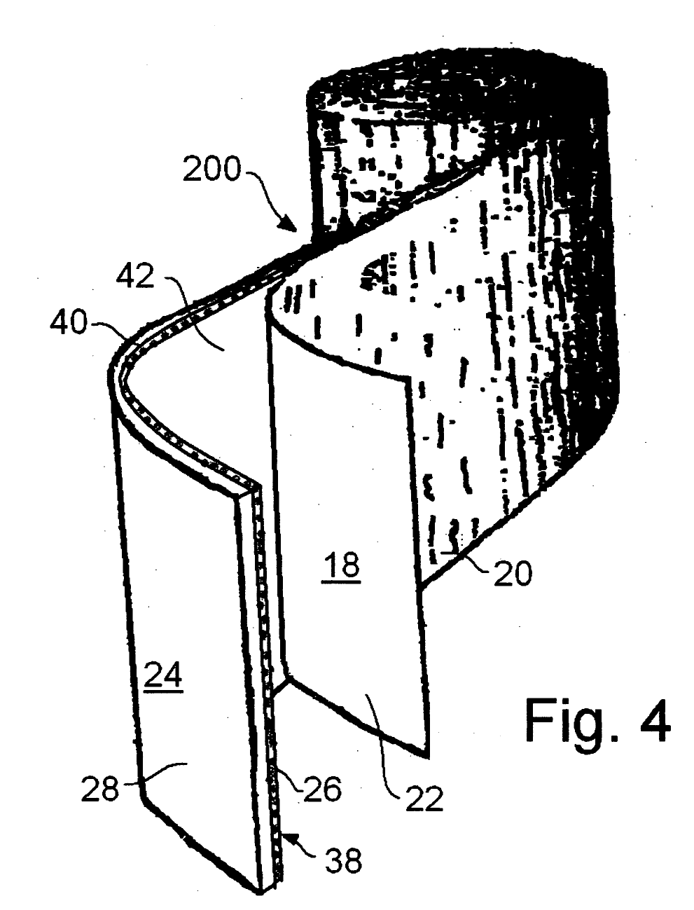

Referring now to FIG. 3, a portion of a third example of a blackout and thermal drapery fabric 200 comprises an extruded impregnated blackout film 38 applied from an extruder 36 to a fabric 24 having a first side 26 and a second side 28. According to FIG. 3, the extruded impregnated blackout film 38 is applied to the first side 26 of the fabric 24. The blackout and thermal drapery fabric 200 is substantially the same as the blackout and thermal drapery fabric 10, except that in the blackout and thermal drapery fabric 200, the extruded impregnated blackout film 38 is directly applied to the fabric 24, rather than being laminated (see FIGS. 1 and 4 and the description of the blackout and thermal drapery fabric 10 above). For this reason, the same reference numbers used in describing the features of the blackout and thermal drapery fabric 10 will be used when describing the identical features of the blackout and thermal drapery fabric 200.

Referring to FIG. 4, the blackout and thermal drapery fabric 200 comprises an extruded impregnated blackout film 38 having a first side 40 and a second side 42, a fabric having a first side 26 and a second side 28 and a layer of acrylic latex 18 having a first side 20 and a second side 22. It should be understood that in addition to acrylic, urethanes or a blend of urethane and acrylic is also contemplated as earlier described for the blackout and thermal drapery fabric 10. The first side 40 of the impregnated blackout film 38 is coupled to the first side 26 of the fabric 24 during the extruding step as described above. There is no need to provide a plastisol adhesive as earlier described for laminating the impregnated blackout film 12 to the fabric 24 of the blackout and thermal drapery fabric 10, resulting in greater manufacturing efficiency and beneficial economics. The second side 22 of the layer of acrylic latex 18 is coupled to the second side 42 of the extruded impregnated blackout film 38. The first side 20 of the layer of acrylic latex may be flocked as described above for the blackout and thermal drapery fabric 10, although it is understood that substantial benefit may be derived from a non-flocked version of the blackout and thermal drapery fabric 200. The extruded impregnated blackout film 38 comprises a thermoplastic impregnated with an ingredient of at least a metal component, at least a pigment, at least a dye or any combination of at least a metal component, at least a pigment and at least a dye, as described above for the impregnated blackout film 12 of the blackout and thermal drapery fabric 10. The extruded impregnated blackout film 38 has a thickness similar to the impregnated blackout film 12 of the blackout and thermal drapery fabric 10 (see description above). Similarly, the fabric 24 of the blackout and thermal drapery fabric 200 comprises either woven or non-woven natural or synthetic fibers as described for the blackout and thermal drapery fabric 10 (see description above). The extruded impregnated blackout film 38, the fabric 24 and the layer of acrylic latex 18 of the blackout and thermal drapery fabric 200 may be fire retardant as described for the blackout and thermal drapery fabric 10 (see description above).

it is clearly understood that the blackout and thermal drapery fabric 200 comprising the extruded impregnated blackout film 38 may also be a second example of a blackout and thermal drapery lining fabric similar to the blackout and thermal drapery lining fabric 50 coupled to the second fabric 30 to provide the blackout and thermal drapery-fabric 100 (see FIG. 2).

While the invention has been particularly shown and described with reference to preferred embodiments thereof, it will be understood by those skilled in the art that the foregoing and other changes in form and details may be made therein without departing from the spirit and scope of the invention.

What is claimed is:

1. A blackout and thermal drapery fabric comprising, in combination: an impregnated blackout film having a first side and a second side, said impregnated blackout film adapted to achieve light inhibition and thermal diminution; a fabric located on one side of said impregnated blackout film and having a first side and a second side, said first side of said fabric coupled to said second side of said impregnated blackout film; and a layer of acrylic latex located on an opposite side of said impregnated blackout film and having a first side and a second side, said first side of said layer of acrylic latex coated to said first side of said impregnated blackout film to provide the blackout and thermal drapery.

2. The blackout and thermal drapery fabric according to claim 1 wherein said impregnated blackout film comprises a thermoplastic including at least one of polyvinyl chloride, polyester, nylon, polypropylene, polyurethane, polyethylene, polyvinyl acetate, copolymers of each of polyvinyl chloride, polyester, nylon, polypropylene, polyurethane, polyethylene and polyvinyl acetate.

3. The blackout and thermal drapery fabric according to claim 2 wherein said thermoplastic is impregnated with at least an ingredient selected from the group consisting of at least a metal component, at least a pigment and at least a dye, so long as said ingredient of said impregnated blackout film is capable of providing light inhibition and thermal diminution.

4. The blackout and thermal drapery fabric according to claim 1 wherein said impregnated blackout film comprising a thermoplastic impregnated with aluminum, said impregnated blackout film having a thickness of at least 0.06 millimeters.

5. The blackout and thermal drapery fabric according to claim 2 wherein said impregnated blackout film comprising a thermoplastic impregnated with at least a pigment, said impregnated blackout film having a thickness of at least 0.07 millimeters.

6. The blackout and thermal drapery fabric according to claim 3 wherein said ingredient comprising said impregnated blackout film having an optical rating of greater than about 1.5.

7. The blackout and thermal drapery fabric according to claim 1 wherein said second side of said layer of acrylic latex comprises a flock.

8. The blackout and thermal drapery fabric according to claim 7 wherein said flock comprises at least one of natural and synthetic fibers selected from the group consisting of cotton, rayon, polyester and nylon.

9. The blackout and thermal drapery fabric according to claim 1 wherein at least one of said impregnated blackout film, said fabric and said acrylic latex comprising a flame retardant.

10. The blackout and thermal drapery fabric according to claim 1 wherein said fabric comprises at least one of natural and synthetic woven fibers selected from the group consisting of polyester, nylon, cotton, polyethylene and polypropylene.

11. The blackout and thermal drapery fabric according to claim 1 wherein said fabric comprises at least one of natural and synthetic non-woven fibers selected from the group consisting of polyester, nylon, cotton, polyethylene and polypropylene.

12. A blackout and thermal drapery lining fabric comprising, in combination: an impregnated blackout film having a first side and a second side, said impregnated blackout film adapted to achieve light inhibition and thermal diminution; a fabric located on one side of said impregnated blackout film and having a first side and a second side, said first side of said fabric coupled to said second side of said impregnated blackout film; and a layer of acrylic latex located on an opposite side of said impregnated blackout film and having a first side and a second side, said first side of said layer of acrylic latex coated to said first side of said impregnated blackout film to provide the blackout and thermal drapery lining fabric dimensioned to be lined to a second fabric located on an opposite side of said fabric and having a first side and a second side.

13. The blackout and thermal drapery lining fabric according to claim 12 wherein said second side of said fabric of said impregnated blackout and thermal drapery lining is coupled to said first side of said second fabric to provide a blackout and thermal drapery fabric.

14. The blackout and thermal drapery lining fabric according to claim 12 wherein said impregnated blackout film comprises a thermoplastic including at least polyvinyl chloride.

15. The blackout and thermal drapery lining fabric according to claim 12 wherein said impregnated blackout film comprising a thermoplastic impregnated with at least an ingredient selected from the group consisting of at least a metal component, at least a pigment and at least a dye, so long as said ingredient of said impregnated blackout film is capable of providing light inhibition and thermal diminution.

16. The blackout and thermal drapery lining fabric according to claim 12 wherein said second side of said layer of acrylic latex comprises a flock, said flock comprising at least one of natural and synthetic fibers selected from the group consisting of cotton, rayon, polyester and nylon.

17. The blackout and thermal drapery lining fabric according to claim 12 wherein at least one of said impregnated blackout film, said first fabric and said acrylic latex comprising a flame retardant.

18. A blackout and thermal drapery fabric comprising, in combination: an impregnated blackout film having a first side and a second side, said impregnated blackout film adapted to achieve light inhibition and thermal diminution; a first fabric located on one side of said impregnated blackout film and having a first side and a second side, said first side of said first fabric coupled to said second side of said impregnated blackout film; a second fabric located on an opposite side of said first fabric and having a first side and a second side, said second side of said first fabric coupled to said first side of said second fabric; and a layer of acrylic latex located on an opposite side of said impregnated blackout film and having a first side and a second side, said first side of said layer of acrylic latex coated to said first side of said impregnated blackout film to provide the blackout and thermal drapery fabric.

19. The blackout and thermal drapery fabric according to claim 18 wherein said impregnated blackout film comprises a thermoplastic including at least polyvinyl chloride.

20. The blackout and thermal drapery fabric according to claim 19 wherein said thermoplastic is impregnated with at least an ingredient selected from the group consisting of at least a metal component, at least a pigment and at least a dye, so long as said ingredient of said impregnated blackout film is capable of providing light inhibition and thermal diminution.

21. The blackout and thermal drapery fabric according to claim 18 wherein said second fabric comprises at least one of natural and synthetic non-woven fibers selected from the group consisting of polyester, nylon, cotton, polyethylene and polypropylene so that said second fabric may be decorated and printed on without any discoloration.

22. A blackout and thermal drapery fabric comprising, in combination: an extruded impregnated blackout film, said extruded impregnated blackout film adapted to achieve light inhibition and thermal diminution; a fabric located on one side of said extruded impregnated blackout film and having a first side and a second side; said extruded impregnated blackout film applied to the first side of said fabric; and a layer of acrylic latex located on an opposite side of said extruded impregnated blackout film and having a first side and a second side, said first side of said layer of acrylic latex coated to said first side of said extruded impregnated blackout film to provide the blackout and thermal drapery fabric.

23. The blackout and thermal drapery fabric according to claim 22 wherein said extruded impregnated blackout film comprises a thermoplastic including at least one of polyvinyl chloride, polyester, nylon, polypropylene, polyurethane, polyethylene, polyvinyl acetate, copolymers of each of polyvinyl chloride, polyester, nylon, polypropylene, polyurethane, polyethylene and polyvinyl acetate.

24. The blackout and thermal drapery fabric according to claim 22 wherein said extruded impregnated blackout film comprising a thermoplastic impregnated with at least an ingredient selected from the group consisting of at least a metal component, at least a pigment and at least a dye, so long as said ingredient of said extruded impregnated blackout film is capable of providing light inhibition and thermal diminution.

25. The blackout and thermal drapery fabric according to claim 22 wherein said second side of said layer of acrylic latex comprises a flock, said flock comprising at least one of natural and synthetic fibers selected from the group consisting of cotton, rayon, polyester and nylon.

26. The blackout and thermal drapery fabric according to claim 22 wherein at least one of said extruded impregnated blackout film, said first fabric and said acrylic latex comprising a flame retardant.

27. A method for manufacturing a blackout and thermal drapery fabric, comprising, in combination, the steps of:
providing an impregnated blackout film having a first side and a second side, said impregnated blackout film adapted to achieve light inhibition and thermal diminution;
providing a fabric located on one side of said impregnated blackout film and having a first side and a second side;
coupling said first side of said fabric to said second side of said impregnated blackout film;
providing a layer of acrylic latex located on an opposite side of said impregnated blackout film and having a first side and a second side; and
coating said first side of said layer of acrylic latex to said first side of said impregnated blackout film to provide the blackout and thermal drapery fabric.

28. The method for manufacturing a blackout and thermal drapery fabric according to claim 27 further comprising the steps of:
providing a second fabric located on an opposite side of said fabric and having a first side and a second side; and
coupling said first side of said second fabric to said second side of said fabric, so that said second side of said second fabric may be decorated and printed on without any discoloration.

29. A method for manufacturing a blackout and thermal drapery fabric, comprising, in combination, the steps of:
providing at least an ingredient for an extruded impregnated blackout film, said ingredient for said extruded impregnated blackout film adapted to achieve light inhibition and thermal diminution;
providing a fabric located on one side of said extruded impregnated blackout film and having a first side and a second side;
extruding said ingredient to the first side of said fabric to provide said extruded impregnated blackout film;
providing a layer of acrylic latex located on an opposite side of said extruded impregnated blackout film and having a first side and a second side; and
coating said first side of said layer of acrylic latex to said first side of said extruded impregnated blackout film to provide the blackout and thermal drapery fabric.

30. A method for manufacturing a blackout and thermal drapery lining fabric, comprising, in combination, the steps of:
providing an impregnated blackout film having a first side and a second side, said impregnated blackout film adapted to achieve light inhibition and thermal diminution;
providing a fabric located on one side of said impregnated blackout film and having a first side and a second side;
coupling said first side of said fabric to said second side of said impregnated blackout film; and
coating a layer of acrylic latex located on an opposite side of said impregnated blackout film having a first side and a second side to said first side of said impregnated blackout film to provide the blackout and thermal drapery lining fabric dimensioned to be lined to a second fabric located on an opposite side of said fabric and having a first side and a second side.
